(19) United States
(12) Patent Application Publication
(10) Pub. No.: US 2026/0154887 A1
(43) Pub. Date: Jun. 4, 2026

(54) EFFECT VIDEO GENERATION METHOD, APPARATUS, ELECTRONIC DEVICE, AND STORAGE MEDIUM

(71) Applicant: Beijing Zitiao Network Technology Co., Ltd., Beijing (CN)

(72) Inventors: Fei DAI, Beijing (CN); Xu BAI, Beijing (CN); Jiawei LIU, Beijing (CN); Siyu ZHOU, Beijing (CN)

(21) Appl. No.: 19/406,681

(22) Filed: Dec. 2, 2025

(30) Foreign Application Priority Data
Dec. 2, 2024 (CN) 202411757940.5

(51) Int. Cl. G06T 13/00; G06F 40/40

(52) U.S. Cl. CPC G06T 13/00; G06F 40/40

(57) ABSTRACT

Embodiments of the present disclosure provide an effect video generation method and apparatus, an electronic device, and a storage medium. An image to be processed is acquired; a target image is generated based on the image to be processed, where the target image is an image generated by applying a target effect to a target object in the image to be processed, and the target object in the target image has a resulting effect generated by the target effect; and a video generation model is invoked to process the image to be processed and the target image to generate an effect video, where the effect video includes a video first frame, a video last frame, and at least one video middle frame located between the video first frame and the video last frame, the video first frame has the same image content as the image to be processed.

### CROSS REFERENCE TO RELATED APPLICATIONS

This present application claims the benefit of priority to Chinese Application No. 2024117579405, filed on Dec. 2, 2024, the entire contents of which are incorporated herein by reference.

### TECHNICAL FIELD

Embodiments of the present disclosure relate to the field of Internet technologies, and in particular, to an effect video generation method and apparatus, an electronic device, and a storage medium.

### BACKGROUND

Currently, in a scenario of video generation based on Artificial Intelligence (AI) technology, a user may input a static picture and a sentence describing video content into a video generation model, to generate a corresponding video, thereby achieving an effect of making the picture “move”.

### SUMMARY

Embodiments of the present disclosure provide an effect video generation method and apparatus, an electronic device, and a storage medium.

In a first aspect, an embodiment of the present disclosure provides an effect video generation method, including:
acquiring an image to be processed; generating a target image based on the image to be processed, where the target image is an image generated by applying a target effect to a target object in the image to be processed, and the target object in the target image has a resulting effect generated by the target effect; and invoking a video generation model to process the image to be processed and the target image to generate an effect video, where the effect video includes a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect.

In a second aspect, an embodiment of the present disclosure provides an effect video generation apparatus, including:
an acquisition module, configured to acquire an image to be processed;
a first generation module, configured to generate a target image based on the image to be processed, where the target image is an image generated by applying a target effect to a target object in the image to be processed, and the target object in the target image has a resulting effect generated by the target effect; and
a second generation module, configured to invoke a video generation model to process the image to be processed and the target image to generate an effect video, where the effect video includes a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect.

In a third aspect, an embodiment of the present disclosure provides an electronic device, including: a processor and a memory;
the memory stores a computer-executable instruction; and
the processor executes the computer-executable instruction stored in the memory to cause the at least one processor to execute the effect video generation method according to the first aspect and various possible designs of the first aspect.

In a fourth aspect, an embodiment of the present disclosure provides a computer-readable storage medium, where a computer-executable instruction is stored in the computer-readable storage medium, and when the computer-executable instruction is executed by a processor, the effect video generation method according to the first aspect and various possible designs of the first aspect is implemented.

In a fifth aspect, an embodiment of the present disclosure provides a computer program product, including a computer program, and when the computer program is executed by a processor, the effect video generation method according to the first aspect and various possible designs of the first aspect is implemented.

According to the effect video generation method and apparatus, the electronic device, and the storage medium provided in the embodiments, an image to be processed is acquired; a target image is generated based on the image to be processed, where the target image is an image generated by applying a target effect to a target object in the image to be processed, and the target object in the target image has a resulting effect generated by the target effect; and a video generation model is invoked to process the image to be processed and the target image to generate an effect video, where the effect video includes a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect. The target image with the effect is generated based on the image to be processed firstly, and then the video generation model is invoked to process the image to be processed and the target image to obtain the video middle frame representing the continuous change process of the resulting effect from the image to be processed to the target image, and finally the effect video composed of the video first frame, the video middle frame and the video last frame is generated.

### BRIEF DESCRIPTION OF THE DRAWINGS

In order to more clearly explain the technical solutions in the embodiments of the present disclosure or in the related art, the following will briefly introduce the drawings that need to be configured in the description of the embodiments or the related art. Obviously, the drawings in the following description are some embodiments of the present disclosure. For those of ordinary skill in the art, other drawings may be obtained based on these drawings without paying creative efforts.

FIG. 1 is an application scenario diagram of an effect video generation method provided by an embodiment of the present disclosure;

FIG. 2 is a first flowchart of an effect video generation method provided by an embodiment of the present disclosure;

FIG. 3 is a schematic diagram of a target image provided by an embodiment of the present disclosure;

FIG. 4 is a flowchart of a specific implementation of step S102 in the embodiment shown in FIG. 2;

FIG. 5 is a flowchart of a specific implementation of step S1022 in the embodiment shown in FIG. 4;

FIG. 6 is a flowchart of a specific implementation of step S103 in the embodiment shown in FIG. 2;

FIG. 7 is a second flowchart of an effect video generation method provided by an embodiment of the present disclosure;

FIG. 8 is a flowchart of a specific implementation of step S205 in the embodiment shown in FIG. 7;

FIG. 9 is a flowchart of a specific implementation of step S2053 in the embodiment shown in FIG. 8;

FIG. 10 is a schematic diagram of a process of generating an effect video provided by an embodiment of the present disclosure;

FIG. 11 is a structural block diagram of an effect video generation apparatus provided by an embodiment of the present disclosure;

FIG. 12 is a structural schematic diagram of an electronic device provided by an embodiment of the present disclosure; and

FIG. 13 is a schematic hardware structural diagram of an electronic device provided by an embodiment of the present disclosure.

### DETAILED DESCRIPTION OF EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the described embodiments are part of the embodiments of the present disclosure, not all of them. Based on the embodiments in the present disclosure, all other embodiments obtained by those of ordinary skill in the art without paying creative efforts belong to the protection scope of the present disclosure.

It should be noted that the user information (including but not limited to user device information, user personal information, etc.) and data (including but not limited to data for analysis, stored data, displayed data, etc.) involved in the present disclosure are all information and data authorized by users or fully authorized by all parties, and the collection, use and processing of relevant data need to comply with relevant laws, regulations and standards of relevant countries and regions, and provide corresponding operation entrances for users to choose to authorize or reject.

The application scenarios of the embodiments of the present disclosure are explained below:

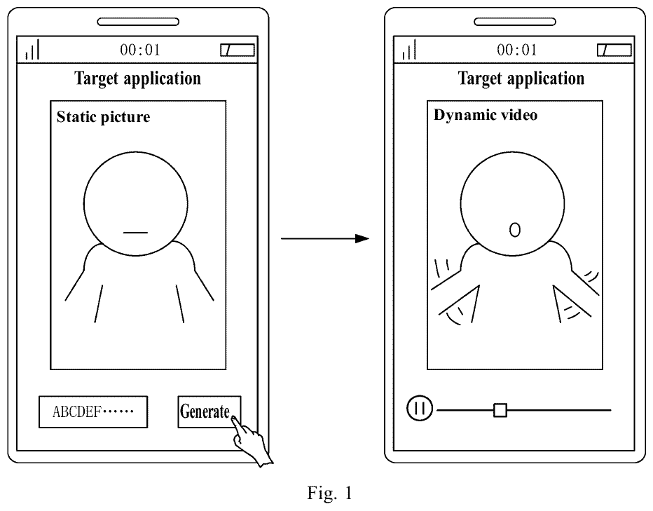

FIG. 1 is an application scenario diagram of an effect video generation method provided by an embodiment of the present disclosure. The effect video generation method provided by the embodiment of the present disclosure may be applied to an application (APP) with an effect video generation function, such as a video generation application, etc. More specifically, it may be applied to an application scenario of effect video generation. An execution body of this embodiment may be a terminal device running the above application with the effect video generation function, or a server deploying a server side corresponding to the above application, or other electronic devices that play similar functions. When the execution body is a terminal device, the terminal device runs the above application to execute the method provided by this embodiment; when the execution body is a server, the server side of the above application with the effect video generation function may run partially or completely on the server, and the method provided by this embodiment is executed on the server side, while the terminal device runs a client of the application, with the server and the terminal device being based on the server-client communication, so that the terminal device may obtain an execution result of the method provided by this embodiment and display it according to needs.

In some embodiments, the terminal device or the server may implement the effect video generation method provided by the embodiment of the present disclosure by running various computer-executable instructions or computer programs. For example, the computer-executable instructions may be program-level commands, machine instructions or software instructions. The computer program may be a native program or a software module in an operating system; it may be a local application, that is, a program that needs to be installed in the operating system to run, or a mini-program embedded in any APP, that is, a program that runs based on a browser environment. In summary, the above computer-executable instructions may be any form of instructions, and the above computer program may be any form of applications, modules or plugins, and the specific implementation form may be configured according to needs. Further, in the process of implementing the effect video generation method provided by the embodiment of the present disclosure, the terminal device may execute the method by running computer-executable instructions or computer programs set locally, or may execute the method by calling computer-executable instructions or computer programs set in an external server. In some embodiments, the server may be an independent physical server, a server cluster or a distributed system composed of multiple physical servers, or may provide cloud services, cloud storage, cloud communication, cloud databases, cloud computing, cloud functions, network services, middleware services, domain name services, security services, content delivery networks (CDN), and cloud servers for basic cloud computing services such as big data and artificial intelligence platforms, where the cloud services may be interactive processing services for the terminal device to call.

Referring to FIG. 1, taking a terminal device as an example, a target application with an effect video generation function runs in the terminal device, and a static picture (for example, a selfie uploaded by a user) input by the user is loaded through the target application, and then, in response to a trigger operation of the user (for example, clicking a “generate” button), a video generation model deployed in the cloud or locally is invoked to convert the static picture into a corresponding dynamic video. In this process, the target application may further receive a description sentence (shown as ABCDEF in the figure) input by the user, and control video content of the generated video according to the description sentence, so as to generate a dynamic video that meets the preferences and needs of the user; or, the user controls content of a corresponding effect video generated based on the static image by selecting an effect card (effect control) provided by the target application.

In the related art, in a special video content generation scenario, such as an effect video generation scenario for a hairstyle effect, a clothing effect, an animal-to-human effect, etc., due to the particularity of such complex effects, a solution in the related art cannot generate a real and coherent video with such a complex effect, that is, there is a problem of poor authenticity and coherence of the generated complex effect video. It is necessary to accurately represent appearance features of the complex effect and its change process. However, the solution in the related art only uses a static image as a starting point to generate subsequent video frames, which often leads to an uncontrolled change process of the generated video frames, resulting in poor coherence between the video frames, and a large difference between a last frame of the video and an expected effect, and finally the generated effect video has problems of incoherence and poor authenticity.

An embodiment of the present disclosure provides an effect video generation method to overcome a problem of poor authenticity and coherence of a generated video with an effect.

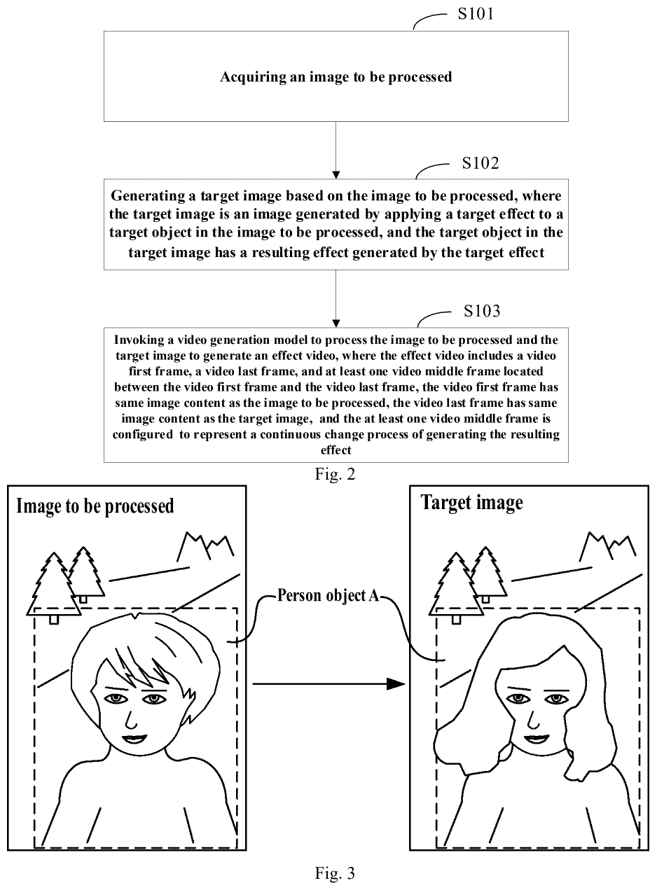

Referring to FIG. 2, FIG. 2 is a first flowchart of an effect video generation method provided by an embodiment of the present disclosure. The method of this embodiment may be applied to a terminal device or a server, and the effect video generation method includes:
Step S101: acquiring an image to be processed.
Step S102: generating a target image based on the image to be processed, where the target image is an image generated by applying a target effect to a target object in the image to be processed, and the target object in the target image has a resulting effect generated by the target effect.

Referring to the schematic diagram of the application scenario shown in FIG. 1, in this embodiment, the provided effect video generation method is introduced by using the terminal device as an execution body. Exemplarily, first, after running a target application, the terminal device receives an image uploaded by a user through the target application, that is, the image to be processed, and the image to be processed is used as a starting point for generating a final effect video. Specifically, the image to be processed is, for example, an image containing a specific object, such as a life photo uploaded by the user, and the object is, for example, an object such as a person or an animal as a main body of image content. After that, the terminal device processes the image to be processed by using a capability provided by the target application to generate the target image, where the target image is an image in which the target effect is added to the image to be processed, that is, a target effect image corresponding to the image to be processed. The target effect is an effect configured to add a resulting effect of a target category to the target object, where an object is an object that changes due to the addition of the effect, such as “hair” that changes in a hairstyle effect, a “person” in a clothing change effect, an “animal” in an animal-to-human effect, and so on. FIG. 3 is a schematic diagram of a target image provided by an embodiment of the present disclosure. As shown in FIG. 3, exemplarily, the image to be processed is a picture containing a person object A (target object). Referring to the figure, a hairstyle that the person object A currently has is, for example, a first hairstyle (short hair). After the terminal device processes the image to be processed by invoking a corresponding algorithm and model, the target image is generated. The person object A is still contained in the target image, but the hairstyle of the person object A becomes a second hairstyle (long hair), and the second hairstyle is the resulting effect of the target category generated by the target effect. In other possible implementations, with a change in a type of the video effect, the generated target image also changes accordingly. For example, in a scenario of a “clothing change effect” (not shown in the figure), the target object is a person object B in the image to be processed, and the person object B has a first clothing. After the terminal device processes the image to be processed by invoking a corresponding algorithm and model, the target image is generated. The person object B (target object) is still contained in the target image, but the clothing of the person object B becomes a second clothing of other styles, and the second clothing is a resulting effect after the target effect is applied to the target object in the image to be processed.

Further, in other possible scenarios, the target effect may also be other video effects such as an “animal-to-human effect”, a “human-to-animal effect”, and an “object material change effect”. The generated target image changes with the target effect, and finally content of the effect video generated based on the target image also changes. That is, the solution provided in this embodiment may be applied to effect video generation in different scenarios, which may be specifically set according to needs and is not limited in this embodiment.

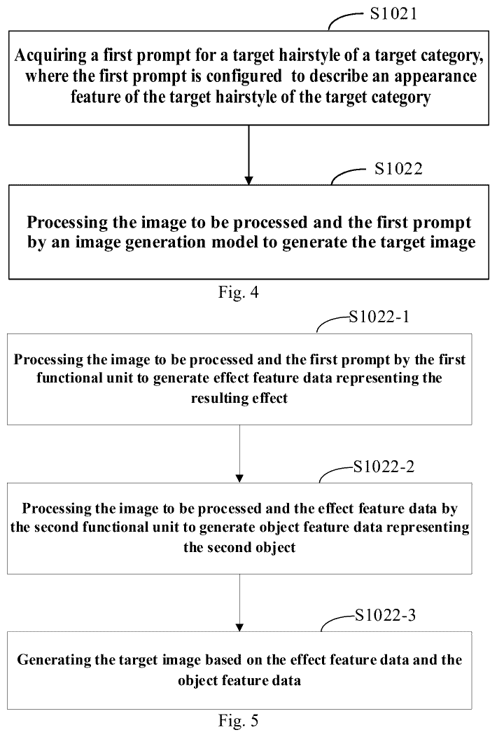

Further, in a possible implementation, as shown in FIG. 4, a specific implementation of step S102 includes:
Step S1021: acquiring a first prompt for the resulting effect of the target category, where the first prompt is configured to describe an appearance feature of the resulting effect of the target category.
Step S1022: processing the image to be processed and the first prompt by an image generation model to generate the target image.

Exemplarily, in a process of generating the target image, the terminal device invokes the image generation model to complete the step of the target image. Specifically, the image generation model is a pre-trained neural network model configured to regenerate an input image according to a prompt. The terminal device first receives the first prompt for input through the running target application, and the first prompt is configured to describe the appearance feature of the resulting effect of the target category. For example, content of the first prompt includes: “long curly hair”, “plump and dense natural small curls”, and so on. After that, the image to be processed and the first prompt are input into the image generation model, and the image content in the image to be processed is “modified” into an image (that is, the target image) containing the resulting effect of the target category described by the first prompt by using the capability of the image generation model, which is the above process and a process of implementing the target effect. The first prompt may be preset configuration information, which is dynamically determined according to the image content of the image to be processed, or may be information input by the user, which may be specifically set according to needs.

In this embodiment, the appearance feature of the resulting effect of the target category is defined by the first prompt, so as to achieve precise control of a visual effect of the target effect, making the effect more diverse, differentiated and refined, and finally improving the authenticity and visual representation of the generated effect video.

Further, in a possible implementation, the image generation model includes a first functional unit and a second functional unit, the first functional unit is configured to generate the resulting effect of the target category, and the second functional unit is configured to generate a second object matching the resulting effect based on the target object, and appearance similarity between the second object and the target object is greater than a similarity threshold. As shown in FIG. 5, a specific implementation of step S1022 includes:
Step S1022-1: processing the image to be processed and the first prompt by the first functional unit to generate effect feature data representing the resulting effect.
Step S1022-2: processing the image to be processed and the effect feature data by the second functional unit to generate object feature data representing the second object.
Step S1022-3: generating the target image based on the effect feature data and the object feature data.

Exemplarily, in a possible implementation, the image generation model includes the first functional unit and the second functional unit, where the first functional unit is configured to generate the resulting effect of the target category. For example, the first functional unit has an ability of hairstyle editing, for example, generating feature data corresponding to hairstyles such as short hair, curly hair, long golden straight hair, etc., and the feature data may be a pixel set, or other feature vectors or matrices that need further decoding to represent an image picture. The image to be processed and the first prompt are processed by the first functional unit, and the corresponding feature data is generated based on the appearance feature described by the first prompt, and the feature data may implement an image or feature description of the resulting effect of the target category. The second functional unit is configured to generate the object feature data representing the second object, that is, the second functional unit has an ability of editing the object. For example, feature data corresponding to a human face, an animal face and a physical contour in the image to be processed is generated, that is, the target object in the image to be processed is edited into the second object (that is, for example, achieving a “face change” effect), so that the second object in the generated target image matches the resulting effect generated by the first functional unit better, improving the image authenticity. On the other hand, high similarity between the target object and the second object is maintained, so that most of the appearance features of the target object in the image to be processed may be retained, improving consistency between the main object (second object) in the target image with the target effect added and the main object (target object) in the image to be processed without the target effect added.

Further, in a possible implementation, the first prompt includes a first word segmentation, a second word segmentation and a third word segmentation, where the first word segmentation is configured to indicate the target object; the second word segmentation is configured to represent a shape feature of the target effect; and the third word segmentation is configured to represent a style feature of the target effect. That is, the first prompt consists of three parts, which are the first word segmentation, the second word segmentation and the third word segmentation, where the first word segmentation is configured to control where the image generation model generates the resulting effect (target object); the second word segmentation is configured to control a local appearance form (shape feature) of the resulting effect of the image generation model, such as a hair shape, a color, etc. ; and the third word segmentation is configured to represent an overall feature (style feature) of the resulting effect, such as hair fluffiness, a curly arc of the hair, density, etc. Through the above first word segmentation, second word segmentation and third word segmentation, finer control of the target effect may be achieved, so that the generated target image and the effect video generated based on the target image may better meet the needs of the user and have better visual effects.
Step S103: invoking a video generation model to process the image to be processed and the target image to generate an effect video, where the effect video includes a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect.

Exemplarily, after the target image is generated, image content of the image to be processed is used as first frame content of the effect video, and image content of the target image is used as last frame content of the effect video, and the video generation model is invoked to generate continuously changing video middle frame content between the first frame content and the last frame content, so as to obtain a video (that is, the effect video) configured to describe a continuous change of the resulting effect from the first frame content to the last frame content. The video generation model has an ability to generate a continuously changing image between two static images based on the two static images, and the ability is obtained by pre-training based on training samples, which will not be repeated here.

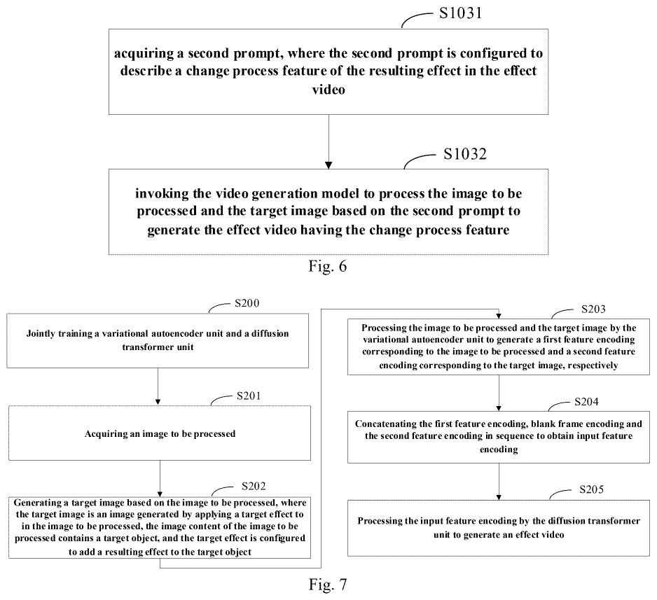

In a possible implementation, as shown in FIG. 6, a specific implementation of step S103 includes:
Step S1031: acquiring a second prompt, where the second prompt is configured to describe a change process feature of the resulting effect in the effect video.
Step S1032: invoking the video generation model to process the image to be processed and the target image based on the second prompt to generate the effect video having the change process feature.

Exemplarily, before invoking the video generation model, the terminal device first acquires the second prompt. Similar to the first prompt, the second prompt may be preset configuration information or information input by the user, which may be specifically set according to needs. The second prompt is configured to describe the change process feature of the resulting effect in the effect video, for example, content of the second prompt includes: “hair gradually becomes curly and fluffy, with a natural, progressive and smooth dynamic.” Through the above second prompt, the change process of the effect video may be controlled, so that the change process from the image content of the image to be processed to the image content of the target image is more precise, meeting personalized needs of the user, and at the same time making the generated effect video more real. It should be noted that the content of the second prompt in this embodiment is only exemplary, and the specific content of the second prompt may be set according to needs, which will not be repeated here.

In this embodiment, an image to be processed is acquired; a target image is generated based on the image to be processed, where the target image is an image in which a target effect is added to the image to be processed, image content of the image to be processed contains a target object, and the target effect is configured to add a resulting effect of a target category to the target object; and a video generation model is invoked to process the image to be processed and the target image to generate an effect video, where the effect video includes a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect. The target image with the effect is generated based on the image to be processed firstly, and then the video generation model is invoked to process the image to be processed and the target image to obtain the video middle frame representing the continuous change process of the resulting effect from the image to be processed to the target image, and finally the effect video composed of the video first frame, the video middle frame and the video last frame is generated. While ensuring the authenticity of the effect through the video last frame, the content change of the effect video is smoother and more real, and the video quality of the effect video is improved.

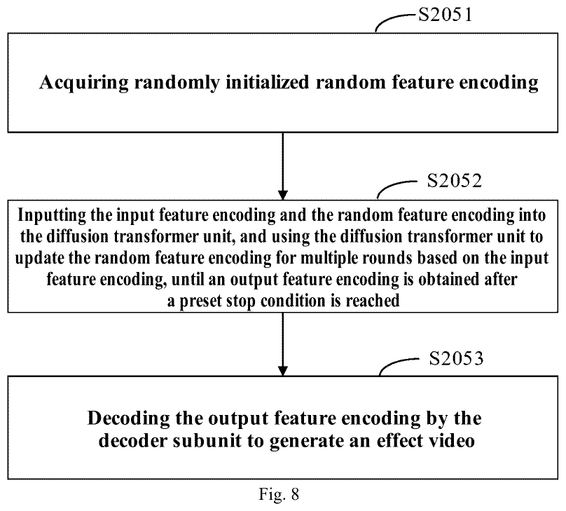

Referring to FIG. 7, FIG. 7 is a second flowchart of an effect video generation method provided by an embodiment of the present disclosure. In this embodiment, step S103 is further detailed on the basis of the embodiment shown in FIG. 2. In this embodiment, the video generation model includes a variational autoencoder unit and a diffusion transformer unit, and the effect video generation method includes:
Step S200, jointly training the variational autoencoder unit and the diffusion transformer unit.
Step S201: acquiring an image to be processed.
Step S202: generating a target image based on the image to be processed, where the target image is an image in which a target effect is added to the image to be processed, image content of the image to be processed contains a target object, and the target effect is configured to add a resulting effect of a target category to the target object.

Step S203: processing the image to be processed and the target image by the variational autoencoder unit to generate a first feature encoding corresponding to the image to be processed and a second feature encoding corresponding to the target image, respectively.
Step S204: concatenating the first feature encoding, blank frame encoding and the second feature encoding in sequence to obtain input feature encoding.
Step S205: processing the input feature encoding by the diffusion transformer unit to generate the effect video.

Exemplarily, after the target image is generated, the image to be processed and the target image are processed by invoking the video generation model to generate the effect video, where the video generation model includes a variational auto-encoder (VAE) unit and a diffusion transformer unit. The variational autoencoder is a generative model that combines ideas of an autoencoder and a probabilistic graphical model, and is mainly configured to learn a potential distribution of data and generate new data samples. The diffusion transformer is a deep learning model based on diffusion models, and is mainly configured for image and video generation and transformation. In this embodiment, the variational autoencoder unit implemented based on the variational autoencoder is configured to encode the image to be processed and the target image to form the corresponding first feature encoding and the second feature encoding corresponding to the target image, respectively, and is configured to decode the feature encoding output by the diffusion transformer to restore it to a corresponding multi-frame image in a subsequent step, thereby obtaining a final video. In this embodiment, the diffusion transformer unit implemented based on the diffusion transformer is configured to perform prediction according to the encoded feature encoding to generate encoded features corresponding to multi-frames of continuously changing images, in short, to generate continuously changing image pictures from the image picture corresponding to the image to be processed to the image picture corresponding to the target image, that is, a continuous change process of the resulting effect.

Specifically, in this embodiment, the terminal device first processes the image to be processed and the target image by the variational autoencoder unit to generate the first feature encoding corresponding to the image to be processed and the second feature encoding corresponding to the target image, respectively, that is, encodes the image to be processed and the target image. After that, a blank encoding having a same size as that of the first feature encoding and the second feature encoding is generated, and the first feature encoding, the blank frame encoding and the second feature encoding are concatenated in sequence to obtain the input feature encoding. Finally, the input feature encoding is input into the diffusion transformer unit, and the diffusion transformer unit performs encoding prediction to generate encoded features corresponding to one or more frames of continuously changing images between the image picture of the image to be processed and the image picture of the target image. This step performed by the diffusion transformer is equivalent to a process of generating the blank encoding in the input feature encoding through the first feature encoding and the second feature encoding in the input feature encoding. Finally, the feature encoding output by the diffusion transformer is decoded into corresponding video frames by the variational autoencoder, thereby generating the effect video.

Further, the variational autoencoder unit includes an encoder subunit and a decoder subunit, and a specific implementation of step S203 includes:
Step S2031: encoding the image to be processed and the target image by the encoder subunit to generate the first feature encoding corresponding to the image to be processed and the second feature encoding corresponding to the target image, respectively.

Correspondingly, as shown in FIG. 8, an implementation of step S205 includes:
Step S2051: acquiring randomly initialized random feature encoding.
Step S2052: inputting the input feature encoding and the random feature encoding into the diffusion transformer unit, and using the diffusion transformer unit to update the random feature encoding for multiple rounds based on the input feature encoding, until an output feature encoding is obtained after a preset stop condition is reached.
Step S2053: decoding the output feature encoding by the decoder subunit to generate the effect video.

Exemplarily, firstly, the terminal device obtains a feature encoding array, vector or matrix through random initialization, and the random feature encoding corresponds to N video frames, that is, the random feature encoding will be configured to generate an N-frame effect video subsequently. After that, using the input feature encoding and the random feature encoding generated in the previous step as input, the diffusion transformer unit is invoked, and the diffusion transformer unit is configured to update the random feature encoding for multiple rounds based on the input feature encoding, until a preset stop condition is reached, such as a number of updates reaches a preset value, or a residual is less than a preset value, etc. The output feature encoding output by the diffusion transformer unit is obtained, and the output feature encoding is a result of multiple rounds of iterative updates on the random feature encoding. In the above process, the pre-trained diffusion transformer unit is configured to perform reasoning with the first feature encoding and the second feature encoding in the input feature encoding as valid information, to obtain the output feature encoding containing middle frame encoding that “connects” the first feature encoding and the second feature encoding. The middle frame encoding may show a feature change from the first feature encoding to the second feature encoding, and the image generated after decoding the timing frame encoding may show an image picture change from the image to be processed to the target image, and conforms to a real law of hairstyle (hair) growth. Therefore, the effect video generated by the output feature encoding may coherently and realistically show an appearance process of the target effect in the video, and has stronger visual expressiveness.

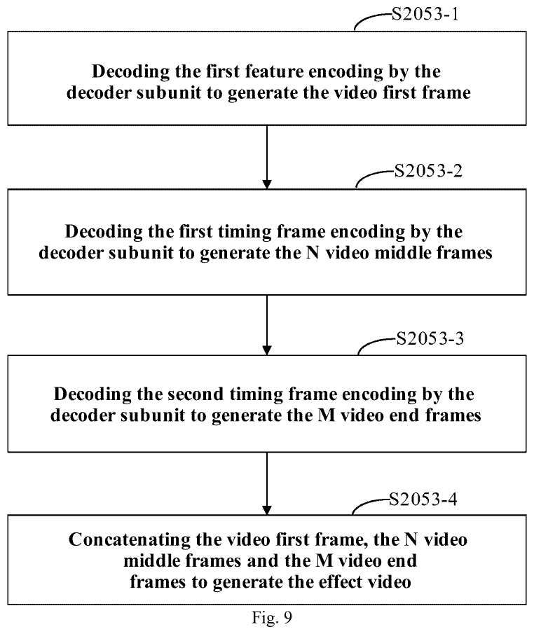

Further, in a possible implementation, the output feature encoding includes the first feature encoding, first timing frame encoding and second timing frame encoding, where the first timing frame encoding is generated based on the first feature encoding, and is configured to represent image content of N continuously changing video frames after the video first frame of the effect video; and the second timing frame encoding is generated based on the first timing frame encoding and the second feature encoding, and is configured to represent image content of M continuously changing video frames at a video end of the effect video, where N and M are integers greater than 0. As shown in FIG. 9, a specific implementation of step S2053 includes:
Step S2053-1: decoding the first feature encoding by the decoder subunit to generate the video first frame;
Step S2053-2: decoding the first timing frame encoding by the decoder subunit to generate the N video middle frames;
Step S2053-3: decoding the second timing frame encoding by the decoder subunit to generate M video end frames;
Step S2053-4: concatenating the video first frame, the N video middle frames and the M video end frames to generate the effect video.

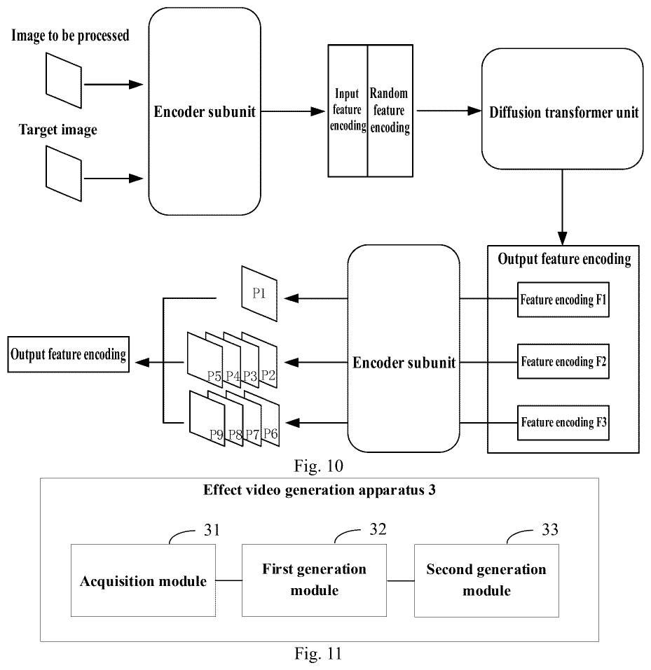

Exemplarily, FIG. 10 is a schematic diagram of a process of generating an effect video provided by an embodiment of the present disclosure. The above process will be described in detail below in conjunction with FIG. 10. Referring to the figure, firstly, the input feature encoding is generated through the encoder subunit, and then the input feature encoding and the random feature encoding are input into the diffusion transformer unit to obtain the output feature encoding output by the diffusion transformer unit. The output feature encoding includes feature encoding F1 (first feature encoding), feature encoding F2 (first timing frame encoding) and feature encoding F3 (second timing frame encoding). After that, through the decoder subunit, the first feature encoding is directly decoded firstly to generate the video first frame, that is, a first frame of the effect video, which is shown as P1 in the figure. In this step, restoration of the image to be processed is achieved. After that, the feature encoding F2 is decoded by the decoder subunit to generate the N video middle frames, where N is, for example, 4, and as shown in the figure, the four video middle frames are P2, P3, P4 and P5, respectively, that is, the feature encoding F2 is configured to generate P2, P3, P4 and P5, a total of four video middle values located after the video first frame, that is, second to fifth frames of the effect video. After that, the feature encoding F3 is decoded by the decoder subunit to generate the M video end frames, where M is, for example, 4, and as shown in the figure, the four video middle frames are P6, P7, P8 and P9, respectively, a total of four video frames located at the video end, that is, sixth to ninth frames of the effect video. Finally, the above nine video frames are combined to obtain the effect video.

In a possible implementation, in this embodiment, a prompt, such as the first prompt and/or the second prompt, may be further combined to achieve control over generation processes of the target image and the effect video. For example, the second prompt is applied to the variational autoencoder unit and the diffusion transformer unit, thereby achieving control over the generation process of the effect video. Specific usages of the first prompt and the second prompt have been introduced in detail in the embodiment shown in FIG. 2, and will not be repeated here.

In this embodiment, firstly, through the trained diffusion transformer unit, image features of the N video middle frames and image features of the M video end frames are respectively compressed into one feature encoding (the first timing frame encoding and the second timing frame encoding) based on the first feature encoding, and then combined with the variational autoencoder unit jointly trained with the diffusion transformer unit, the first feature encoding corresponding to the video first frame, the first timing frame encoding corresponding to the N video middle frames and the second timing frame encoding corresponding to the M video end frames are restored to the video first frame, the N video middle frames and the M video end frames, thus realizing generation of the effect video. The beginning and the end of the effect video may accurately match the originally input video to be edited and the target video with the effect added, that is, content process control of the effect video is realized, and problems such as an uncontrollable change process of each video frame of the effect video, video content distortion, and a large difference between the video last frame and an expected effect (target effect) are avoided, improving coherence and authenticity of the generated effect video and providing visual perception of the effect video.

In this embodiment, implementations of step 201 to step S202 are the same as those of step S101 to step S102 in the embodiment shown in FIG. 2 of the present disclosure, which will not be repeated here.

Corresponding to the effect video generation method of the above embodiments, FIG. 11 is a structural block diagram of an effect video generation apparatus provided by an embodiment of the present disclosure. The method introduced in the above embodiments may be executed by the effect video generation apparatus, and the apparatus may be implemented by software and/or hardware, and the apparatus may be integrated in an electronic device with a certain data processing function. The electronic device may include, but is not limited to, a mobile terminal with big data processing capability, and a fixed terminal with big data processing capability, such as a desktop computer and a supercomputer.

For ease of description, only parts related to the embodiments of the present disclosure are shown. Referring to FIG. 11, the effect video generation apparatus 3 includes:
an acquisition module 31, configured to acquire an image to be processed;
a first generation module 32, configured to generate a target image based on the image to be processed, where the target image is an image generated by applying a target effect to a target object in the image to be processed, and the target object in the target image has a resulting effect generated by the target effect; and
a second generation module 33, configured to invoke a video generation model to process the image to be processed and the target image to generate an effect video, where the effect video includes a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect.

According to one or more embodiments of the present disclosure, the first generation module 32 is further configured to: acquire a first prompt for the resulting effect of the target category, where the first prompt is configured to describe an appearance feature of the target effect of the target category; and process the image to be processed and the first prompt by an image generation model to generate the target image.

According to one or more embodiments of the present disclosure, the image generation model includes a first functional unit and a second functional unit, the first functional unit is configured to generate the resulting effect of the target category, and the second functional unit is configured to generate a second object matching the resulting effect based on the target object, and appearance similarity between the second object and the target object is greater than a similarity threshold. The first generation module 32, when processing the image to be processed and the first prompt by the image generation model to generate the target image, is further configured to: process the image to be processed and the first prompt by the first functional unit to generate effect feature data representing the resulting effect; process the image to be processed and the effect feature data by the second functional unit to generate object feature data representing the second object; and generate the target image based on the effect feature data and the object feature data.

According to one or more embodiments of the present disclosure, the first prompt includes a first word segmentation, a second word segmentation and a third word segmentation, where the first word segmentation is configured to indicate the target object; the second word segmentation is configured to represent a shape feature of the resulting effect; and the third word segmentation is configured to represent a style feature of the resulting effect.

According to one or more embodiments of the present disclosure, the video generation model includes a variational autoencoder unit and a diffusion transformer unit, and the second generation module 33 is further configured to: process the image to be processed and the target image by the variational autoencoder unit to generate a first feature encoding corresponding to the image to be processed and a second feature encoding corresponding to the target image, respectively; concatenate the first feature encoding, blank frame encoding and the second feature encoding in sequence to obtain input feature encoding; and process the input feature encoding by the diffusion transformer unit to generate the effect video.

According to one or more embodiments of the present disclosure, the variational autoencoder unit includes an encoder subunit and a decoder subunit, and the second generation module 33, when processing the image to be processed and the target image by the variational autoencoder unit to generate the first feature encoding corresponding to the image to be processed and the second feature encoding corresponding to the target image, respectively, is further configured to: encode the image to be processed and the target image by the encoder subunit to generate the first feature encoding corresponding to the image to be processed and the second feature encoding corresponding to the target image, respectively. The second generation module 33, when processing the input feature encoding by the diffusion transformer unit to generate the effect video, is further configured to: acquire randomly initialized random feature encoding; input the input feature encoding and the random feature encoding into the diffusion transformer unit, and use the diffusion transformer unit to update the random feature encoding for multiple rounds based on the input feature encoding, until an output feature encoding is obtained after a preset stop condition is reached; and decode the output feature encoding by the decoder subunit to generate the effect video.

According to one or more embodiments of the present disclosure, the output feature encoding includes the first feature encoding, first timing frame encoding and second timing frame encoding, where the first timing frame encoding is generated based on the first feature encoding, and is configured to represent image content of N continuously changing video frames after the video first frame of the effect video; and the second timing frame encoding is generated based on the first timing frame encoding and the second feature encoding, and is configured to represent image content of M continuously changing video frames at a video end of the effect video.

According to one or more embodiments of the present disclosure, the second generation module 33, when decoding the output feature encoding by the decoder subunit to generate the effect video, is further configured to: decode the first feature encoding by the decoder subunit to generate the video first frame; decode the first timing frame encoding by the decoder subunit to generate the N video middle frames; decode the second timing frame encoding by the decoder subunit to generate the M video end frames; and concatenate the video first frame, the N video middle frames and the M video end frames to generate the effect video.

According to one or more embodiments of the present disclosure, the second generation module 33, when invoking the video generation model to process the image to be processed and the target image to generate the effect video, is further configured to: acquire a second prompt, where the second prompt is configured to describe a change process feature of the resulting effect in the effect video; and invoke the video generation model to process the image to be processed and the target image based on the second prompt to generate the effect video having the change process feature.

The acquisition module 31, the first generation module 32 and the second generation module 33 are connected in sequence. The effect video generation apparatus 3 provided in this embodiment may execute the technical solutions of the above method embodiments, and its implementation principles and technical effects are similar, which will not be repeated here in this embodiment.

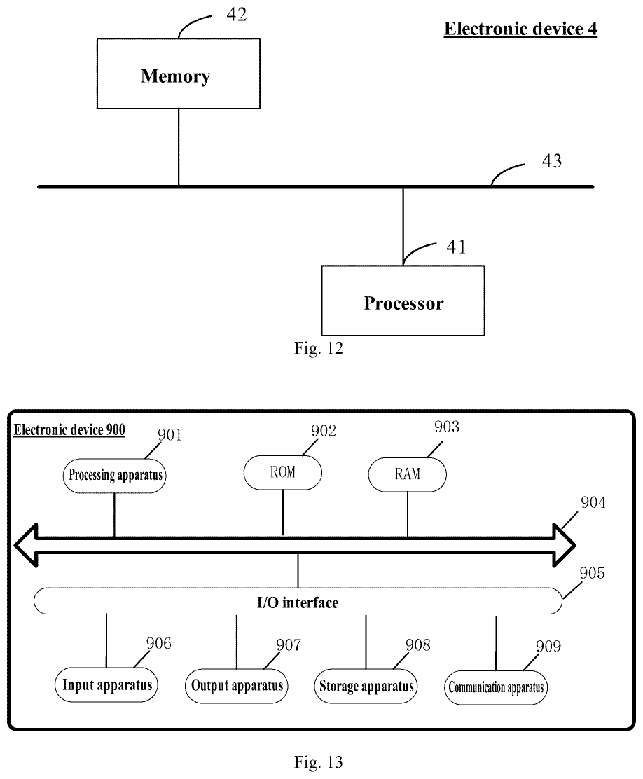

FIG. 12 is a schematic structural diagram of an electronic device provided by an embodiment of the present disclosure. As shown in FIG. 12, the electronic device 4 includes:
a processor 41, and a memory 42 communicatively connected to the processor 41;
the memory 42 stores a computer-executable instruction; and
the processor 41 executes the computer-executable instruction stored in the memory 42 to implement the effect video generation method in the embodiments shown in FIG. 2 to FIG. 10.

Optionally, the processor 41 and the memory 42 are connected through a bus 43.

Relevant descriptions may be understood by referring to relevant descriptions and effects corresponding to steps in the embodiments corresponding to FIG. 2 to FIG. 10, and details are not repeated here.

An embodiment of the present disclosure provides a computer-readable storage medium, where a computer-executable instruction is stored in the computer-readable storage medium, and when the computer-executable instruction is executed by a processor, the effect video generation method provided by any one of the embodiments corresponding to FIG. 2 to FIG. 10 of the present disclosure is implemented.

An embodiment of the present disclosure provides a computer program product, including a computer program, and when the computer program is executed by a processor, the effect video generation method provided by any one of the embodiments corresponding to FIG. 2 to FIG. 10 of the present disclosure is implemented.

In order to implement the above embodiments, an embodiment of the present disclosure further provides an electronic device.

Referring to FIG. 13, it shows a schematic structural diagram of an electronic device 900 suitable for implementing the embodiments of the present disclosure, and the electronic device 900 may be a terminal device or a server. The terminal device may include, but is not limited to, mobile terminals such as a mobile phone, a notebook computer, a digital broadcast receiver, a personal digital assistant (abbreviated as PDA), a tablet computer, a portable media player (abbreviated as PMP), a vehicle-mounted terminal (such as a vehicle navigation terminal), etc., and fixed terminals such as a digital TV, a desktop computer, etc. The electronic device shown in FIG. 13 is only an example, and should not impose any limitation on functions and application scope of the embodiments of the present disclosure.

As shown in FIG. 13, the electronic device 900 may include a processing apparatus (such as a central processing unit, a graphics processor, etc.) 901, which may perform various appropriate actions and processes according to a program stored in read-only memory (abbreviated as ROM) 902 or a program loaded from storage apparatus 908 into random access memory (abbreviated as RAM) 903. In the RAM 903, various programs and data required for operations of the electronic device 900 are also stored. The processing apparatus 901, the ROM 902 and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touchpad, a keyboard, a mouse, a camera, a microphone, an accelerometer, a gyroscope, etc. ; an output apparatus 907 including, for example, a liquid crystal display (abbreviated as LCD), a speaker, a vibrator, etc. ; a storage apparatus 908 including, for example, a magnetic tape, a hard disk, etc. ; and a communication apparatus 909. The communication apparatus 909 may allow the electronic device 900 to perform wireless or wired communication with other devices to exchange data. Although FIG. 13 shows the electronic device 900 with various apparatuses, it should be understood that it is not required to implement or have all of the apparatuses shown. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a computer-readable medium, where the computer program contains program codes for executing the method shown in the flowchart. In such an embodiment, the computer program may be downloaded and installed from a network through the communication apparatus 909, or installed from the storage apparatus 908, or installed from the ROM 902. When the computer program is executed by the processing apparatus 901, the above-mentioned functions defined in the method of the embodiment of the present disclosure are executed.

It should be noted that the above-mentioned computer-readable medium in the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated in a baseband or as a part of a carrier wave, and computer-readable program codes are carried therein. This propagated data signal may take many forms, including but not limited to, an electromagnetic signal, an optical signal, or any suitable combination of the above. The computer-readable signal medium may also be any computer-readable medium other than the computer-readable storage medium, and the computer-readable signal medium may send, propagate or transmit a program for use by or in combination with an instruction execution system, apparatus or device. The program codes contained on the computer-readable medium may be transmitted by any suitable medium, including but not limited to: a wire, an optical cable, RF (radio frequency), etc., or any suitable combination of the above.

The above-mentioned computer-readable medium may be contained in the above-mentioned electronic device, or may exist alone without being assembled into the electronic device.

The above computer-readable medium carries one or more programs, and when the one or more programs are executed by the electronic device, the electronic device is caused to execute the method shown in the above embodiments.

The computer program codes for executing the operations of the present disclosure may be written in one or more programming languages or a combination thereof, where the above programming languages include object-oriented programming languages such as Java, Smalltalk, C++, and also include conventional procedural programming languages such as “C” language or similar programming languages. The program codes may be executed entirely on a user computer, partly executed on a user computer, executed as an independent software package, partly executed on a user computer and partly executed on a remote computer, or entirely executed on a remote computer or a server. In the case of involving a remote computer, the remote computer may be connected to the user computer through any kind of network, including a local area network (abbreviated as LAN) or a wide area network (abbreviated as WAN), or it may be connected to an external computer (for example, connected through the Internet using an Internet service provider).

The flowcharts and block diagrams in the drawings illustrate the possibly implemented architectures, functions and operations of the system, method and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and the combination of the blocks in the block diagram and/or the flowchart may be implemented by a special purpose hardware-based system that executes specified functions or operations, or may be implemented by a combination of special purpose hardware and computer instructions.

The involved units or modules described in the embodiments of the present disclosure may be implemented by software or hardware. Among them, the name of the unit or module does not constitute a limitation on the unit itself under certain circumstances.

The functions described above herein may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

In a first aspect, according to one or more embodiments of the present disclosure, an effect video generation method is provided, including:
acquiring an image to be processed; generating a target image based on the image to be processed, where the target image is an image in which a target effect is added to the image to be processed, image content of the image to be processed includes a target object, and the target effect is configured to add a resulting effect of a target category to the target object; and invoking a video generation model to process the image to be processed and the target image to generate an effect video, where the effect video includes a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect.

According to one or more embodiments of the present disclosure, the generating the target image based on the image to be processed includes: acquiring a first prompt for the resulting effect of the target category, where the first prompt is configured to describe an appearance feature of the resulting effect of the target category; and processing the image to be processed and the first prompt by an image generation model to generate the target image.

According to one or more embodiments of the present disclosure, the image generation model includes a first functional unit and a second functional unit, the first functional unit is configured to generate the resulting effect of the target category, and the second functional unit is configured to generate a second object matching the resulting effect based on the target object, and appearance similarity between the second object and the target object is greater than a similarity threshold. The processing the image to be processed and the first prompt by the image generation model to generate the target image includes: processing the image to be processed and the first prompt by the first functional unit to generate effect feature data representing the resulting effect; processing the image to be processed and the effect feature data by the second functional unit to generate object feature data representing the second object; and generating the target image based on the effect feature data and the object feature data.

According to one or more embodiments of the present disclosure, the first prompt includes a first word segmentation, a second word segmentation and a third word segmentation, where the first word segmentation is configured to indicate the target object; the second word segmentation is configured to represent a shape feature of the resulting effect; and the third word segmentation is configured to represent a style feature of the resulting effect.

According to one or more embodiments of the present disclosure, the video generation model includes a variational autoencoder unit and a diffusion transformer unit, and the invoking the video generation model to process the image to be processed and the target image to generate the effect video includes: processing the image to be processed and the target image by the variational autoencoder unit to generate a first feature encoding corresponding to the image to be processed and a second feature encoding corresponding to the target image, respectively; concatenating the first feature encoding, blank frame encoding and the second feature encoding in sequence to obtain input feature encoding; and processing the input feature encoding by the diffusion transformer unit to generate the effect video.

According to one or more embodiments of the present disclosure, the variational autoencoder unit includes an encoder subunit and a decoder subunit, and the processing the image to be processed and the target image by the variational autoencoder unit to generate the first feature encoding corresponding to the image to be processed and the second feature encoding corresponding to the target image, respectively, includes: encoding the image to be processed and the target image by the encoder subunit to generate the first feature encoding corresponding to the image to be processed and the second feature encoding corresponding to the target image, respectively. The processing the input feature encoding by the diffusion transformer unit to generate the effect video includes: acquiring randomly initialized random feature encoding; inputting the input feature encoding and the random feature encoding into the diffusion transformer unit, and using the diffusion transformer unit to update the random feature encoding for multiple rounds based on the input feature encoding, until an output feature encoding is obtained after a preset stop condition is reached; and decoding the output feature encoding by the decoder subunit to generate the effect video.

According to one or more embodiments of the present disclosure, the output feature encoding includes the first feature encoding, first timing frame encoding and second timing frame encoding, where the first timing frame encoding is generated based on the first feature encoding, and is configured to represent image content of N continuously changing video frames after the video first frame of the effect video; and the second timing frame encoding is generated based on the first timing frame encoding and the second feature encoding, and is configured to represent image content of M continuously changing video frames at a video end of the effect video.

According to one or more embodiments of the present disclosure, the decoding the output feature encoding by the decoder subunit to generate the effect video includes: decoding the first feature encoding by the decoder subunit to generate the video first frame; decoding the first timing frame encoding by the decoder subunit to generate the N video middle frames; decoding the second timing frame encoding by the decoder subunit to generate the M video end frames; and concatenating the video first frame, the N video middle frames and the M video end frames to generate the effect video.

According to one or more embodiments of the present disclosure, the invoking the video generation model to process the image to be processed and the target image to generate the effect video includes:
acquiring a second prompt, where the second prompt is configured to describe a change process feature of the resulting effect in the effect video; and invoking the video generation model to process the image to be processed and the target image based on the second prompt to generate the effect video having the change process feature.

In a second aspect, according to one or more embodiments of the present disclosure, an effect video generation apparatus is provided, including:
an acquisition module, configured to acquire an image to be processed;
a first generation module, configured to generate a target image based on the image to be processed, where the target image is an image in which a target effect is added to the image to be processed, image content of the image to be processed includes a target object, and the target effect is configured to add a resulting effect of a target category to the target object; and
a second generation module, configured to invoke a video generation model to process the image to be processed and the target image to generate an effect video, where the effect video includes a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the target effect.

According to one or more embodiments of the present disclosure, the first generation module is further configured to: acquire a first prompt for the resulting effect of the target category, where the first prompt is configured to describe an appearance feature of the resulting effect of the target category; and process the image to be processed and the first prompt by an image generation model to generate the target image.

According to one or more embodiments of the present disclosure, the image generation model includes a first functional unit and a second functional unit, the first functional unit is configured to generate the resulting effect of the target category, and the second functional unit is configured to generate a second object matching the resulting effect based on the target object, and appearance similarity between the second object and the target object is greater than a similarity threshold. The first generation module, when processing the image to be processed and the first prompt by the image generation model to generate the target image, is further configured to: process the image to be processed and the first prompt by the first functional unit to generate effect feature data representing the resulting effect; process the image to be processed and the effect feature data by the second functional unit to generate object feature data representing the second object; and generate the target image based on the effect feature data and the object feature data.

According to one or more embodiments of the present disclosure, the first prompt includes a first word segmentation, a second word segmentation and a third word segmentation, where the first word segmentation is configured to indicate the target object; the second word segmentation is configured to represent a shape feature of the resulting effect; and the third word segmentation is configured to represent a style feature of the resulting effect.

According to one or more embodiments of the present disclosure, the video generation model includes a variational autoencoder unit and a diffusion transformer unit, and the second generation module is further configured to: process the image to be processed and the target image by the variational autoencoder unit to generate a first feature encoding corresponding to the image to be processed and a second feature encoding corresponding to the target image, respectively; concatenate the first feature encoding, blank frame encoding and the second feature encoding in sequence to obtain input feature encoding; and process the input feature encoding by the diffusion transformer unit to generate the effect video.

According to one or more embodiments of the present disclosure, the variational autoencoder unit includes an encoder subunit and a decoder subunit, and the second generation module, when processing the image to be processed and the target image by the variational autoencoder unit to generate the first feature encoding corresponding to the image to be processed and the second feature encoding corresponding to the target image, respectively, is further configured to: encode the image to be processed and the target image by the encoder subunit to generate the first feature encoding corresponding to the image to be processed and the second feature encoding corresponding to the target image, respectively. The second generation module, when processing the input feature encoding by the diffusion transformer unit to generate the effect video, is further configured to: acquire randomly initialized random feature encoding; input the input feature encoding and the random feature encoding into the diffusion transformer unit, and use the diffusion transformer unit to update the random feature encoding for multiple rounds based on the input feature encoding, until an output feature encoding is obtained after a preset stop condition is reached; and decode the output feature encoding by the decoder subunit to generate the effect video.

According to one or more embodiments of the present disclosure, the output feature encoding includes the first feature encoding, first timing frame encoding and second timing frame encoding, where the first timing frame encoding is generated based on the first feature encoding, and is configured to represent image content of N continuously changing video frames after the video first frame of the effect video; and the second timing frame encoding is generated based on the first timing frame encoding and the second feature encoding, and is configured to represent image content of M continuously changing video frames at a video end of the effect video.

According to one or more embodiments of the present disclosure, the second generation module, when decoding the output feature encoding by the decoder subunit to generate the effect video, is further configured to: decode the first feature encoding by the decoder subunit to generate the video first frame; decode the first timing frame encoding by the decoder subunit to generate the N video middle frames; decode the second timing frame encoding by the decoder subunit to generate the M video end frames; and concatenate the video first frame, the N video middle frames and the M video end frames to generate the effect video.

According to one or more embodiments of the present disclosure, the second generation module, when invoking the video generation model to process the image to be processed and the target image to generate the effect video, is further configured to: acquire a second prompt, where the second prompt is configured to describe a change process feature of the resulting effect in the effect video; and invoke the video generation model to process the image to be processed and the target image based on the second prompt to generate the effect video having the change process feature.

In a third aspect, according to one or more embodiments of the present disclosure, an electronic device is provided, including: at least one processor and a memory;
the memory stores a computer-executable instruction; and
the at least one processor executes the computer-executable instruction stored in the memory to cause the at least one processor to execute the effect video generation method according to the first aspect and various possible designs of the first aspect.

In a fourth aspect, according to one or more embodiments of the present disclosure, a computer-readable storage medium is provided, where a computer-executable instruction is stored in the computer-readable storage medium, and when the computer-executable instruction is executed by a processor, the effect video generation method according to the first aspect and various possible designs of the first aspect is implemented.

In a fifth aspect, according to one or more embodiments of the present disclosure, a computer program product is provided, including a computer program, and when the computer program is executed by a processor, the effect video generation method according to the first aspect and various possible designs of the first aspect is implemented.

The above description is only preferred embodiments of the present disclosure and an explanation of applied technical principles. Those skilled in the art should understand that the disclosed scope involved in the present disclosure is not limited to technical solutions formed by specific combinations of the above technical features, and should also cover other technical solutions formed by any combination of the above technical features or their equivalent features without departing from the above disclosed concept. For example, a technical solution formed by replacing the above features with technical features with similar functions disclosed in (but not limited to) the present disclosure.

In addition, although the operations are depicted in a specific order, this should not be understood as requiring the operations to be performed in a specific order shown or in a sequential order. Under certain circumstances, multitasking and parallel processing may be advantageous. Likewise, although several specific implementation details are included in the above discussion, these should not be construed as limiting the scope of the present disclosure. Certain features described in the context of separate embodiments may also be implemented in a single embodiment in combination. Conversely, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only exemplary forms of implementing the claims.

1. An effect video generation method, comprising:
acquiring an image to be processed, wherein the image to be processed comprises a target object;
generating a target image based on the image to be processed, wherein the target image is an image generated by applying a target effect to the target object in the image to be processed, and the target object in the target image has a resulting effect generated by the target effect; and
invoking a video generation model to process the image to be processed and the target image to generate an effect video, wherein the effect video comprises a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect.

2. The method of claim 1, wherein the generating the target image based on the image to be processed comprises:
acquiring a first prompt for the resulting effect of a target category, wherein the first prompt is configured to describe an appearance feature of the resulting effect of the target category; and
processing the image to be processed and the first prompt by an image generation model to generate the target image.

3. The method of claim 2, wherein the image generation model comprises a first functional unit and a second functional unit, the first functional unit is configured to generate the resulting effect of the target category, and the second functional unit is configured to generate a second object matching the resulting effect based on the target object, and appearance similarity between the second object and the target object is greater than a similarity threshold; and
the processing the image to be processed and the first prompt by the image generation model to generate the target image comprises:
processing the image to be processed and the first prompt by the first functional unit to generate effect feature data representing the target effect;
processing the image to be processed and the effect feature data by the second functional unit to generate object feature data representing the second object; and
generating the target image based on the effect feature data and the object feature data.

4. The method of claim 2, wherein the first prompt comprises a first word segmentation, a second word segmentation and a third word segmentation, wherein the first word segmentation is configured to indicate the target object; the second word segmentation is configured to represent a shape feature of the resulting effect; and
the third word segmentation is configured to represent a style feature of the resulting effect.

5. The method of claim 1, wherein the video generation model comprises a variational autoencoder unit and a diffusion transformer unit, and the invoking the video generation model to process the image to be processed and the target image to generate the effect video comprises:
processing the image to be processed and the target image by the variational autoencoder unit to generate a first feature encoding corresponding to the image to be processed and a second feature encoding corresponding to the target image, respectively;
concatenating the first feature encoding, blank frame encoding and the second feature encoding in sequence to obtain input feature encoding; and
processing the input feature encoding by the diffusion transformer unit to generate the effect video.

6. The method of claim 5, wherein the variational autoencoder unit comprises an encoder subunit and a decoder subunit, and the processing the image to be processed and the target image by the variational autoencoder unit to generate the first feature encoding corresponding to the image to be processed and the second feature encoding corresponding to the target image, respectively, comprises:
encoding the image to be processed and the target image by the encoder subunit to generate the first feature encoding corresponding to the image to be processed and the second feature encoding corresponding to the target image, respectively; and
the processing the input feature encoding by the diffusion transformer unit to generate the effect video comprises:
acquiring randomly initialized random feature encoding;
inputting the input feature encoding and the random feature encoding into the diffusion transformer unit, and using the diffusion transformer unit to update the random feature encoding for multiple rounds based on the input feature encoding, until an output feature encoding is obtained after a preset stop condition is reached; and
decoding the output feature encoding by the decoder subunit to generate the effect video.

7. The method of claim 6, wherein the output feature encoding comprises the first feature encoding, first timing frame encoding and second timing frame encoding, wherein,
the first timing frame encoding is generated based on the first feature encoding, and is configured to represent image content of N continuously changing video frames after the video first frame of the effect video; and
the second timing frame encoding is generated based on the first timing frame encoding and the second feature encoding, and is configured to represent image content of M continuously changing video frames at a video end of the effect video.

8. The method of claim 7, wherein the decoding the output feature encoding by the decoder subunit to generate the effect video comprises:
decoding the first feature encoding by the decoder subunit to generate the video first frame;
decoding the first timing frame encoding by the decoder subunit to generate the N video middle frames;
decoding the second timing frame encoding by the decoder subunit to generate the M video end frames; and
concatenating the video first frame, the N video middle frames and the M video end frames to generate the effect video.

9. The method of claim 1, wherein the invoking the video generation model to process the image to be processed and the target image to generate the effect video comprises:
acquiring a second prompt, wherein the second prompt is configured to describe a change process feature of the resulting effect in the effect video; and
invoking the video generation model to process the image to be processed and the target image based on the second prompt to generate the effect video having the change process feature.

10. An electronic device, comprising: a processor and a memory;
the memory stores computer-executable instruction; and
the processor executes the computer-executable instruction stored in the memory to cause the processor to execute an effect video generation method, comprising:
acquiring an image to be processed, wherein the image to be processed comprises a target object;
generating a target image based on the image to be processed, wherein the target image is an image generated by applying a target effect to the target object in the image to be processed, and the target object in the target image has a resulting effect generated by the target effect; and
invoking a video generation model to process the image to be processed and the target image to generate an effect video, wherein the effect video comprises a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect.

11. The electronic device of claim 10, wherein the generating the target image based on the image to be processed comprises:
acquiring a first prompt for the resulting effect of a target category, wherein the first prompt is configured to describe an appearance feature of the resulting effect of the target category; and
processing the image to be processed and the first prompt by an image generation model to generate the target image.

12. The electronic device of claim 11, wherein the image generation model comprises a first functional unit and a second functional unit, the first functional unit is configured to generate the resulting effect of the target category, and the second functional unit is configured to generate a second object matching the resulting effect based on the target object, and appearance similarity between the second object and the target object is greater than a similarity threshold; and
the processing the image to be processed and the first prompt by the image generation model to generate the target image comprises:
processing the image to be processed and the first prompt by the first functional unit to generate effect feature data representing the target effect;
processing the image to be processed and the effect feature data by the second functional unit to generate object feature data representing the second object; and
generating the target image based on the effect feature data and the object feature data.

13. The electronic device of claim 11, wherein the first prompt comprises a first word segmentation, a second word segmentation and a third word segmentation, wherein the first word segmentation is configured to indicate the target object; the second word segmentation is configured to represent a shape feature of the resulting effect; and the third word segmentation is configured to represent a style feature of the resulting effect.

14. The electronic device of claim 10, wherein the video generation model comprises a variational autoencoder unit and a diffusion transformer unit, and the invoking the video generation model to process the image to be processed and the target image to generate the effect video comprises:
processing the image to be processed and the target image by the variational autoencoder unit to generate a first feature encoding corresponding to the image to be processed and a second feature encoding corresponding to the target image, respectively;
concatenating the first feature encoding, blank frame encoding and the second feature encoding in sequence to obtain input feature encoding; and
processing the input feature encoding by the diffusion transformer unit to generate the effect video.

15. The electronic device of claim 14, wherein the variational autoencoder unit comprises an encoder subunit and a decoder subunit, and the processing the image to be processed and the target image by the variational autoencoder unit to generate the first feature encoding corresponding to the image to be processed and the second feature encoding corresponding to the target image, respectively, comprises:
encoding the image to be processed and the target image by the encoder subunit to generate the first feature encoding corresponding to the image to be processed and the second feature encoding corresponding to the target image, respectively; and
the processing the input feature encoding by the diffusion transformer unit to generate the effect video comprises:
acquiring randomly initialized random feature encoding;
inputting the input feature encoding and the random feature encoding into the diffusion transformer unit, and using the diffusion transformer unit to update the random feature encoding for multiple rounds based on the input feature encoding, until an output feature encoding is obtained after a preset stop condition is reached; and
decoding the output feature encoding by the decoder subunit to generate the effect video.

16. A non-transitory computer-readable storage medium, wherein computer-executable instruction is stored in the computer-readable storage medium, and the computer-executable instruction, when executed by a processor, causes the processor to implement an effect video generation method, comprising:
acquiring an image to be processed, wherein the image to be processed comprises a target object;
generating a target image based on the image to be processed, wherein the target image is an image generated by applying a target effect to the target object in the image to be processed, and the target object in the target image has a resulting effect generated by the target effect; and
invoking a video generation model to process the image to be processed and the target image to generate an effect video, wherein the effect video comprises a video first frame, a video last frame, and at least one video middle frame located between the video first frame and the video last frame, the video first frame has same image content as the image to be processed, the video last frame has same image content as the target image, and the at least one video middle frame is configured to represent a continuous change process of generating the resulting effect.

17. The non-transitory computer-readable storage medium of claim 16, wherein the generating the target image based on the image to be processed comprises:
acquiring a first prompt for the resulting effect of a target category, wherein the first prompt is configured to describe an appearance feature of the resulting effect of the target category; and
processing the image to be processed and the first prompt by an image generation model to generate the target image.

18. The non-transitory computer-readable storage medium of claim 17, wherein the image generation model comprises a first functional unit and a second functional unit, the first functional unit is configured to generate the resulting effect of the target category, and the second functional unit is configured to generate a second object matching the resulting effect based on the target object, and appearance similarity between the second object and the target object is greater than a similarity threshold; and
the processing the image to be processed and the first prompt by the image generation model to generate the target image comprises:
processing the image to be processed and the first prompt by the first functional unit to generate effect feature data representing the target effect;
processing the image to be processed and the effect feature data by the second functional unit to generate object feature data representing the second object; and
generating the target image based on the effect feature data and the object feature data.

19. The non-transitory computer-readable storage medium of claim 17, wherein the first prompt comprises a first word segmentation, a second word segmentation and a third word segmentation, wherein the first word segmentation is configured to indicate the target object; the second word segmentation is configured to represent a shape feature of the resulting effect; and the third word segmentation is configured to represent a style feature of the resulting effect.

20. The non-transitory computer-readable storage medium of claim 16, wherein the video generation model comprises a variational autoencoder unit and a diffusion transformer unit, and the invoking the video generation model to process the image to be processed and the target image to generate the effect video comprises:
processing the image to be processed and the target image by the variational autoencoder unit to generate a first feature encoding corresponding to the image to be processed and a second feature encoding corresponding to the target image, respectively;
concatenating the first feature encoding, blank frame encoding and the second feature encoding in sequence to obtain input feature encoding; and
processing the input feature encoding by the diffusion transformer unit to generate the effect video.
